(19) United States
(12) Patent Application Publication
(10) Pub. No.: US 2019/0115781 A1
(43) Pub. Date: Apr. 18, 2019

(54) WIRELESS CHARGER

(71) Applicant: Daobin FENG, Shenzhen (CN)

(72) Inventor: Daobin FENG, Shenzhen (CN)

(21) Appl. No.: 15/853,660

(22) Filed: Dec. 22, 2017

(30) Foreign Application Priority Data
Oct. 16, 2017 (CN) 201710960467.4
Oct. 16, 2017 (CN) 201721332556.6

(51) Int. Cl. H02J 7/02; H02J 50/12

(52) U.S. Cl. CPC H02J 7/025; H02J 50/12

(57) ABSTRACT

The present invention discloses a wireless charger, comprising a front shell (1) and a rear shell (6), wherein the front shell comprises a plane and a step seat arranged under the plane, in which a smart phone can be placed to be charged. An electromagnetic induction charging device is arranged between the front shell (1) and the rear shell (6) and comprises a magnetic induction coil (2) for wirelessly charging a smart phone. The rear end of the electromagnetic induction device is provided with a cooling device comprising a cooling fan (3) which extracts air to discharge air in the direction of an air duct; a sealing device (4) configured to seal the air duct and the cooling fan together; and an air duct. The front shell (1) is provided with cooling holes allowing air to enter so as to increase air flow when the cooling fan works.

### CROSS REFERENCE TO RELATED APPLICATIONS

The present application claims priority to Chinese Patent Application CN 201710960467.4 filed on Oct. 16, 2017 and to Chinese Utility Model Application CN 201721332556.6 filed on Oct. 16, 2017.

### TECHNICAL FIELD

The present invention relates to a wireless charger, for example a wireless charger with ultrafast charging capability and with efficient cooling function.

### BACKGROUND

Currently wireless chargers of mobile phones on the market comprise desktop flat-type and bracket-type wireless chargers, which do not contain a cooling structure. In use, such wireless chargers cannot perform electromagnetic induction or work efficiently due to the use of environmental constraints, such as the misalignment; the receiving end of the mobile phone has a large amount of heat, and the receiving terminal must reduce the power to control the heat, so that mobile phones are charged slowly due to charging at a low power.

### SUMMARY

The technical problem to be solved by the present invention is to provide wireless charger for solving the problems in the prior art. The wireless charger may be a wireless charger with ultrafast charging capability and with efficient cooling function.

The technical solution adopted by the present invention to solve the above technical problem is as follows:

A wireless charger, comprising a front shell (1) and a rear shell (6), wherein the front shell comprises a plane and a step seat arranged under the plane, in which a smart phone is placed to be charged; an electromagnetic induction charging device is arranged between the front shell (1) and the rear shell (6) and comprises a magnetic induction coil (2) for wirelessly charging a smart phone; moreover, the rear end of the electromagnetic induction device is provided with a cooling fan device, and the cooling fan device comprises: a cooling fan (3) which extracts air to discharge air in the direction of an air duct; a sealing device (4) configured to seal the air duct and the cooling fan together; and an air duct; the front shell (1) is provided with a ring of cooling holes, and air will enter from the cooling holes to increase air flow when the cooling fan works; moreover, an opening (5) is provided on the rear shell (6), and the opening faces the air duct to dissipate heat.

Moreover, a main circuit board (7) and/or a secondary circuit board (8) are further arranged inside the front shell (1) and the rear shell (6), thus constituting a circuit system of the wireless charger.

The circuit system comprises: a power management circuit, a noise reduction filter circuit, a charger power supply circuit, a resonance circuit, an electromagnetic induction coil, a detection circuit and a control circuit, wherein the power management circuit is connected to the noise reduction filter circuit and the charger power supply circuit, and performs noise reduction and filtering on the charger power supply circuit and finally supplies power to the resonance circuit; the charger power supply circuit is connected to the resonance circuit and the resonance circuit is connected to the electromagnetic induction coil, wherein the resonance circuit supplies power to the electromagnetic induction coil.

The resonance circuit comprises: an MOS transistor and a resonant capacitor, wherein the power supply is connected to the MOS transistor, wherein an MCU processor emits a high frequency signal to control the ON/OFF of the MOS transistor through a high-frequency drive circuit, resulting in a high-frequency signal into the resonant capacitor, which uses the characteristics of rapidly charging and discharging of a capacitor and provides an oscillation frequency to the magnetic induction coil at the rear end of the capacitor, so as to achieve the oscillation source required for electromagnetic induction for power transmission.

The detection circuit comprises: a signal amplification IC in which the signal at the output terminal of the resonant capacitor is connected to the signal amplification IC, the received signal is amplified and is connected to the MCU processor, and the signal at the output terminal is analyzed to determine the operational status of the product.

The control circuit comprises: an MCU processor, which controls an output high-frequency signal of the circuit as a master device, checks whether the power supply is abnormal, checks the output feedback signal, and controls an LED display.

The noise reduction filter circuit comprises: a 3A magnetic bead and a plurality of capacitors 106 and 104, which are configured to input the filtering and shaping of the power supply and is connected to S pole of the MOS transistor.

The power management circuit specifically comprises:

a power management circuit, comprising two QC2.0 9V protocol outputs, one of which is a voltage reduction and stabilization circuit reducing from 9V to 5V, while the other is a voltage division detection circuit:

wherein the QC2.0 9V protocols activate the adapter compatible with QC2.0 protocol or above by controlling D− and D+ output detection signals through the MCU so that the adapter outputs 9V voltage; and

the voltage reduction circuit stabilizes the input power to be 5V to provide power supply to the MCU/fan/LED through a K7412 voltage reduction IC, wherein the voltage division detection circuit uses a voltage divider resistor to divide the input voltage into an MCU-detectable voltage to judge whether the input voltage is normal.

The present invention utilizes the principle of fan cooling to define air holes in the electromagnetic induction area of a mobile phone and increases the cooling effect by increasing the air convection on the contact surface of the mobile phone using the principle of ventilation so as to achieve the best charging effect on the mobile phone terminal. (Actually, in the 6 W charging test, the temperature of the mobile phone may be lowered by 3 degrees centigrade to 8 degrees centigrade.)

Additional features and advantages of the present invention will be set forth in the following description, and in part will be obvious from the description, or may be learned by practice of the invention. The objectives and other advantages of the invention may be realized and attained by the structure particularly pointed out in the written description, claims and accompanying drawings.

### BRIEF DESCRIPTION OF THE DRAWINGS

The present invention is described in detail below with reference to the accompanying drawings to make the above advantages of the present invention clearer, wherein

FIG. 1 is a schematic structural diagram of a wireless charger according to the present invention;

FIG. 2 is a circuit block diagram of a wireless charger according to the present invention.

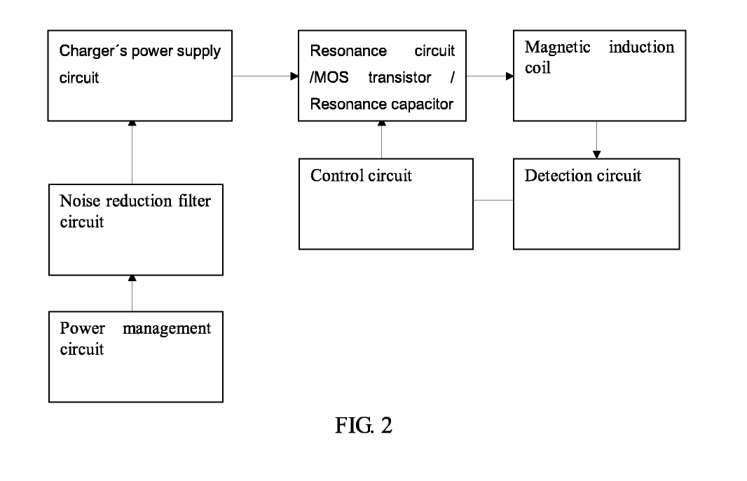

### DESCRIPTION OF THE EMBODIMENTS

The embodiments of the present invention are described in detail below with reference to the accompanying drawings and embodiments, so as to fully understand and implement the implementation process of how to apply the technical means to solve the technical problem and achieve the technical effects by the present invention. It should be noted that, as long as no conflict is formed, each embodiment in the present invention and each feature in each embodiment may be combined with each other, and the formed technical solutions are all within the protection scope of the present invention.

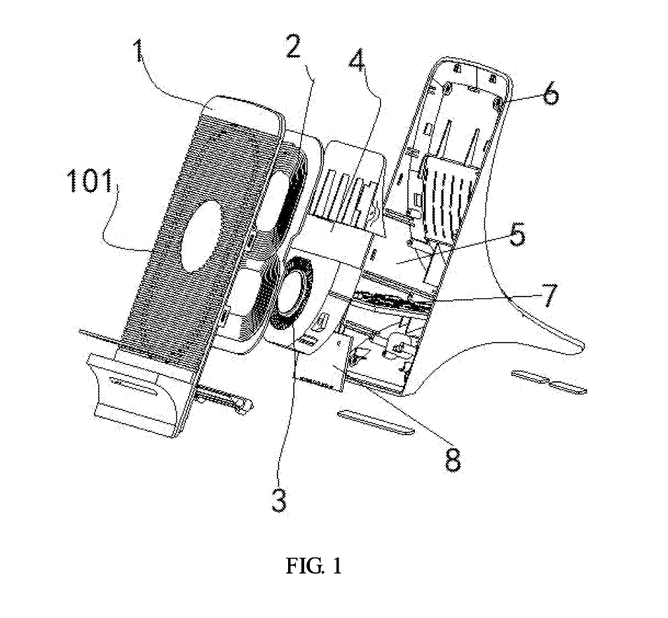

As shown in FIG. 1, the present invention utilizes the principle of fan cooling to define air holes in the electromagnetic induction area of a mobile phone and increases the cooling effect by increasing the air convection on the contact surface of the mobile phone using the principle of ventilation so as to achieve the best charging effect on the mobile phone terminal. (Actually, in the 6 W charging test, the temperature of the mobile phone may be lowered by 3 degrees centigrade to 8 degrees centigrade.)

There are air holes defined in the electromagnetic induction area of the mobile phone. When it is detected that a load is connected to a wireless charger, the ventilation fan in the charger will be turned on to utilize the air convection principle to cool the electromagnetic induction area of the mobile phone.

Moreover, when the mobile phone stops charging due to a high temperature (the mobile phone will turn off charging and cannot be fully charged if the ambient temperature is too high or for the purpose of protecting the battery of the mobile phone, etc.), the wireless charger fan will continue to work until it is detected that the phone is fully charged.

The charger utilizes an electromagnetic induction manner for power transmission.

The electronic part involves:

1. Power Management

Power management is a management of the basic parameters of the input power supply, and the noise reduction filter supplies power to the power supply circuit of the wireless charger.

2. Resonance Circuit

The resonance circuit charges the resonant capacitor and achieves the resonant frequency required for electromagnetic induction through the switching principle of the MOS transistor, and uses the high-performance capacitor discharging principle to supply power to the electromagnetic induction coil at the receiving terminal.

3. Control Circuit.

The MOS transistor is controlled to be ON/OFF to turn on/off the work of the entire circuit, and control the output power by controlling the resonant frequency.

4. Detection Circuit.

The electromagnetic induction signal is used to collect the working condition of the charger and the signal feedback at the receiving terminal, and to protect the various parts of the circuit. For example, it is determined whether the output is opened or closed by the situation of the over-current/over-voltage/over-temperature/abnormal work.

The innovation part of the product is as follows:

1. The cooling structure is proposed and put into effect first.

2. The actual use of the mobile phone terminal is docked first to control the ON state of the cooling fan. If the mobile phone stops charging due to overheating, the fan will be smartly turned on to cool the mobile phone so as to protect the mobile phone battery.

Specifically, a wireless charger comprises a front shell (1) and a rear shell (6), wherein the front shell comprises a plane and a step seat arranged under the plane, in which a smart phone is placed to be charged; an electromagnetic induction charging device is arranged between the front shell (1) and the rear shell (6) and comprises a magnetic induction coil (2) for wirelessly charging a smart phone; moreover, the rear end of the electromagnetic induction device is provided with a cooling fan device, and the cooling fan device comprises: a cooling fan (3) which extracts air to discharge air in the direction of an air duct; a sealing device (4) configured to seal the air duct and the cooling fan together; and an air duct; the front shell (1) is provided with a ring of cooling holes, and air will enter from the cooling holes to increase air flow when the cooling fan works; moreover, an opening (5) is provided on the rear shell (6), and the opening faces the air duct to dissipate heat.

Moreover, a main circuit board (7) and/or a secondary circuit board (8) are further arranged inside the front shell (1) and the rear shell (6), thus constituting a circuit system of the wireless charger.

The circuit system comprises: a power management circuit, a noise reduction filter circuit, a charger power supply circuit, a resonance circuit, an electromagnetic induction coil, a detection circuit and a control circuit, wherein the power management circuit is connected to the noise reduction filter circuit and the charger power supply circuit, and performs noise reduction and filtering on the charger power supply circuit and finally supplies power to the resonance circuit; the charger power supply circuit is connected to the resonance circuit and the resonance circuit is connected to the electromagnetic induction coil, wherein the resonance circuit supplies power to the electromagnetic induction coil.

The resonance circuit comprises: an MOS transistor and a resonant capacitor, wherein the power supply is connected to the MOS transistor, wherein an MCU processor emits a high frequency signal to control the ON/OFF of the MOS transistor through a high-frequency drive circuit, resulting in a high-frequency signal into the resonant capacitor, which uses the characteristics of rapidly charging and discharging of a capacitor and provides an oscillation frequency to the magnetic induction coil at the rear end of the capacitor, so as to achieve the oscillation source required for electromagnetic induction for power transmission.

The detection circuit comprises: a signal amplification IC in which the signal at the output terminal of the resonant capacitor is connected to the signal amplification IC, the received signal is amplified and is connected to the MCU processor, and the signal at the output terminal is analyzed to determine the operational status of the product.

The control circuit comprises: an MCU processor, which controls an output high-frequency signal of the circuit as a master device, checks whether the power supply is abnormal, checks the output feedback signal, and controls an LED display.

The noise reduction filter circuit comprises: a 3 A magnetic bead and a plurality of capacitors 106 and 104, which are configured to input the filtering and shaping of the power supply and is connected to S pole of the MOS transistor.

The power management circuit specifically comprises:

a power management circuit, comprising two QC2.0 9V protocol outputs, one of which is a voltage reduction and stabilization circuit reducing from 9V to 5V, while the other is a voltage division detection circuit:

wherein the QC2.0 9V protocols activate the adapter compatible with QC2.0 protocol or above by controlling D− and D+ output detection signals through the MCU so that the adapter outputs 9V voltage; and

the voltage reduction circuit stabilizes the input power to be 5V to provide power supply to the MCU/fan/LED through a K7412 voltage reduction IC, wherein the voltage division detection circuit uses a voltage divider resistor to divide the input voltage into an MCU-detectable voltage to judge whether the input voltage is normal.

The working principle of the device is as follows: the front shell is provided with a ring of cooling holes, and air will enter from the cooling holes to increase air flow when the cooling fan works. The magnetic induction coil will take away heat at work due to the air circulation. The cooling fan extracts air to discharge air in the direction of an air duct. The air duct and the cooling fan are sealed to ensure that hot air will not overflow. In addition, the air outlet defines opening in the air duct direction, reducing wind resistance and reducing noises.

Working relation: the power supply is connected to the secondary circuit board through a Micro USB, the secondary circuit board is connected with the main circuit board through the cable, the main circuit board detects the power supply and will cycle to self-test and then enter the standby state; the secondary circuit board has LED indicator indicating the status of the product with the condition of the main circuit board. A blue lamp is turned on in the self-test, a green lamp is turned on in the load, and the lamp is turned off when the load is full of signals. The main circuit board detects the output signal through the magnetic induction coil to determine the working status of the product.

Finally, it should be noted that the foregoing descriptions are merely preferred embodiments of the present invention and are not used to limit the present invention. Although the present invention is described in detail with reference to the foregoing embodiments, it will be apparent to those skilled in the art that the technical solutions described in each of the foregoing embodiments may be modified or some technical features in the embodiments may be equivalently replaced. Any modification, equivalent replacement, improvement, etc. made within the spirit and principle of the present invention should be comprised in the protection scope of the present invention.

What is claimed is:

1. A wireless charger, comprising a front shell and a rear shell, wherein the front shell comprises a plane and a step seat arranged under the plane, in which a smart phone can be placed to be charged; an electromagnetic induction charging device is arranged between the front shell and the rear shell and comprises a magnetic induction coil for wirelessly charging a smart phone; moreover, the rear end of the electromagnetic induction device is provided with a cooling fan device, and the cooling fan device comprises: a cooling fan which extracts air to discharge air in the direction of an air duct; a sealing device configured to seal the air duct and the cooling fan together; and an air duct; the front shell is provided with a ring of cooling holes, and air will enter from the cooling holes to increase air flow when the cooling fan works; moreover, an opening is provided on the rear shell, and the opening faces the air duct to dissipate heat.

2. The wireless charger according to claim 1, wherein a main circuit board and/or a secondary circuit board are further arranged inside the front shell and the rear shell, thus constituting a circuit system of the wireless charger.

3. The wireless charger according to claim 2, wherein the circuit system comprises: a power management circuit, a noise reduction filter circuit, a charger power supply circuit, a resonance circuit, an electromagnetic induction coil, a detection circuit and a control circuit, wherein the power management circuit is connected to the noise reduction filter circuit and the charger power supply circuit, and performs noise reduction and filtering on the charger power supply circuit and finally supplies power to the resonance circuit; the charger power supply circuit is connected to the resonance circuit and the resonance circuit is connected to the electromagnetic induction coil, wherein the resonance circuit supplies power to the electromagnetic induction coil.

4. The wireless charger according to claim 3, wherein the resonance circuit comprises:
an MOS transistor and a resonant capacitor, wherein the power supply is connected to the MOS transistor, wherein an MCU processor emits a high frequency signal to control the ON/OFF of the MOS transistor through a high-frequency drive circuit, resulting in a high-frequency signal into the resonant capacitor, which uses the characteristics of rapidly charging and discharging of a capacitor and provides an oscillation frequency to the magnetic induction coil at the rear end of the capacitor, so as to achieve the oscillation source required for electromagnetic induction for power transmission.

5. The wireless charger according to claim 3, wherein the detection circuit comprises:
a signal amplification IC in which the signal at the output terminal of the resonant capacitor is connected to the signal amplification IC, the received signal is amplified and is connected to the MCU processor, and the signal at the output terminal is analyzed to determine the operational status of the product.

6. The wireless charger according to claim 3, wherein the control circuit comprises: an MCU processor, which controls an output high-frequency signal of the circuit as a master device, checks whether the power supply is abnormal, checks the output feedback signal, and controls an LED display.

7. The wireless charger according to claim 3, wherein the noise reduction filter circuit comprises: a 3 A magnetic bead and a plurality of capacitors 106 and 104, which are configured to input the filtering and shaping of the power supply and is connected to S pole of the MOS transistor.

8. The wireless charger according to claim 1, wherein the power management circuit specifically comprises:
a power management circuit, comprising two QC2.0 9V protocol outputs, one of which is a voltage reduction and stabilization circuit reducing from 9V to 5V, while the other is a voltage division detection circuit:
wherein the QC2.0 9V protocols activate the adapter compatible with QC2.0 protocol or above by controlling D− and D+ output detection signals through the MCU so that the adapter outputs 9V voltage; and
the voltage reduction circuit stabilizes the input power to be 5V to provide power supply to the MCU/fan/LED through a K7412 voltage reduction IC, wherein the voltage division detection circuit uses a voltage divider resistor to divide the input voltage into an MCU-detectable voltage to judge whether the input voltage is normal.

9. The wireless charger according to claim 2, wherein the power management circuit specifically comprises:
a power management circuit, comprising two QC2.0 9V protocol outputs, one of which is a voltage reduction and stabilization circuit reducing from 9V to 5V, while the other is a voltage division detection circuit:
wherein the QC2.0 9V protocols activate the adapter compatible with QC2.0 protocol or above by controlling D− and D+ output detection signals through the MCU so that the adapter outputs 9V voltage; and
the voltage reduction circuit stabilizes the input power to be 5V to provide power supply to the MCU/fan/LED through a K7412 voltage reduction IC, wherein the voltage division detection circuit uses a voltage divider resistor to divide the input voltage into an MCU-detectable voltage to judge whether the input voltage is normal.
